(19) United States
(12) Patent Application Publication
(10) Pub. No.: US 2014/0093857 A1
(43) Pub. Date: Apr. 3, 2014

(54) Method of Facilitating Online and Socially Networked Education Between Learning Institutions

(71) Applicant: Stacey Simmons, Sylmar, CA (US)

(72) Inventor: Stacey Simmons, Sylmar, CA (US)

(73) Assignee: GRYPHON DIGITAL MEDIA CORPORATION, Port Allen, LA (US)

(21) Appl. No.: 13/632,054

(22) Filed: Sep. 30, 2012

(51) Int. Cl. G09B 5/08

(52) U.S. Cl. CPC G09B 5/08
USPC 434/350

(57) ABSTRACT

A method is provided of facilitating online education between learning institutions, including the steps of obtaining an e-learning course from a content provider learning institution; obtaining the approval of a subscriber learning institution for students enrolled at such institution to receive academic credit for the successful completion of such e-learning course; enrolling students from such subscriber learning institution in such e-learning course through a website; providing such e-learning course to students of the subscriber learning institution; obtaining an evaluation of the students' performances in the e-learning course from the content provider learning institution; providing said evaluations of the students' performances in such e-learning course to the subscriber learning institution in which the students are enrolled; and providing remuneration to the subscriber learning institution and content provider learning institution.

### BACKGROUND OF THE INVENTION

1. Field of the Invention

The present invention generally relates to online education, otherwise known as “e-learning”. More particularly, the present invention relates to facilitating online education between learning institutions.

2. Description of the Related Art

The Internet and its ability to share information without geographic restriction has revolutionized many industries. In the 1990's peer-to-peer file sharing of music downloads led to a new model of distribution for the recorded music industry. This advance, and the business and technology practices that followed it, revolutionized how consumers now think of acquiring non-physical products such as music, movies, and television shows.

This revolution has expanded to the distribution of information generally, as evidenced by the success of the websites iTunes.com, youtube.com, myspace.com, and facebook.com. All of these commercial enterprises are revolutionizing culture—a generation of students who have no experience with vinyl records, cassette tapes or videotapes. In the near future there will be little need or demand for physical storage devices of information such as CD's or DVD's.

The message in this history is that the supply side of the equation changed very little, but the distribution side changed radically. Survival of traditional supply side providers is and will become more dependent upon the providers' ability to maintain their hold on the business practices and intellectual property that were the industry stock in trade, while satisfying the demand for universal distribution through the Internet.

Compare this with the dilemma facing higher education. Online education, otherwise known as “e-learning”, is not new. For years universities, colleges and other learning institutions have struggled with how best to implement e-learning. While many universities and colleges offer education through e-learning, students seeking to obtain academic credit for e-learning courses are often limited to either taking courses offered only by the learning institution in which they are enrolled, or assuming the high burden of finding e-learning courses on their own at other learning institutions and seeking to obtain the approval of their learning institution for receiving academic credit for such e-learning course.

Various attempts have been made to make the e-learning experience more educational to the user. U.S. Pat. No. 6,975,833 discloses a system, method and data structure to provide more integrated collaboration between students in e-learning courses. U.S. Pat. No. 6,988,138 discloses a system and methods for implementing online education by providing institutions with means for creating e-learning courses by institutions and individuals, so that anyone with access to the Internet can offer e-learning courses. Similarly, U.S. Pat. No. 7,029,280 discloses an e-learning course editor. However, all of these attempts are directed toward the interaction between student and instructor, or student with other students, they do not enable inter-institutional offering of e-learning courses.

Other various attempts have been made at making the e-learning experience more available to the user through offline means. U.S. Pat. No. 7,153,137 discloses a method of creating offline courses so that students may take e-learning courses without reconnecting to the e-learning system after the initial download of the course. U.S. Pat. No. 7,237,189 discloses a system of e-learning by which the student may take courses offline, while the state of the user and his/her participation is maintained online. However, all of these attempts are directed at making e-learning courses more accessible to users by enabling such courses to be taken offline, they do not enable inter-institutional offering of e-learning courses.

Still further various attempts have been made to assist a student in tailoring his/her e-learning experience to match the student. U.S. Pat. No. 6,325,632 discloses a method of matching students and instructors, based on information about the students and instructors. U.S. Pat. No. 6,827,578 discloses a system, method and software for generating a navigation path through a course based on a particular learning strategy. U.S. Pat. No. 6,944,624 discloses a method and system for creating and implementing a personalized training program based on skill level and knowledge of the user received from surveys from the user's peers, superiors and the user. U.S. Pat. No. 6,884,074 discloses a method of creating e-learning courses tailored to the student based on certain specific needs of the student, such as the student's budget and other criteria provided by the student. U.S. Pat. No. 7,003,502 discloses a method for enabling the creation of a community of users based on certain criteria, and enabling the sharing of knowledge to such community. U.S. Pat. No. 7,082,418 discloses a system and method of creating a personalized education to a student, based on comparing the student's competency profile to an education template, identifying target learning areas, and providing information to the student relevant to the target learning areas. However, all of these attempts are directed at creating a more personalized e-learning educational experience, they do not enable inter-institutional offering of e-learning courses.

Therefore, there is need for a new method which enables learning institutions to offer to their students e-learning courses provided by other learning institutions. Further, there is need for a new method which enables learning institutions to selectively offer e-learning courses to the students of other learning institutions. Further, there is need for a new method which enables inter-institution standardization of performance evaluation for students taking e-learning courses from a learning institution other than the one in which the student is enrolled. Further, there is need for a new method which enables the inter-institution transfer of academic credit for students taking e-learning courses from learning institutions other than the one in which the student is enrolled. Further, there is need for a new method of financial remuneration which makes inter-institution offering of e-learning courses a financially viable proposition for the learning institutions. Various embodiments of a method are offered here which meet certain of these needs.

### SUMMARY OF THE INVENTION

A method of facilitating online education between learning institutions is provided. (Definitions in the Detailed Description of the Preferred Embodiment apply to this Summary.) The method includes the steps of obtaining an e-learning course, taught by an instructor, and course materials from a content provider learning institution; providing the applicable e-learning course syllabus to a subscriber learning institution for the review and approval of such subscriber learning institution for students enrolled at such subscriber learning institution to receive academic credit for the successful completion of such e-learning course; obtaining the approval of such subscriber learning institution for students enrolled at such subscriber learning institution to receive academic credit for the successful completion of such e-learning course; enrolling students from such subscriber learning institution in such e-learning course through a website; providing such e-learning course to students of the subscriber learning institution; obtaining evaluations of the students' performances in the e-learning course from the content provider learning institution;

providing said evaluations of the students' performances in such e-learning course to the subscriber learning institution in which the students are enrolled, and providing remuneration to the subscriber learning institution and content provider learning institution.

### BRIEF DESCRIPTION OF THE DRAWINGS

So that the manner in which the above recited features of the present invention can be better understood, certain drawings are appended hereto. It is to be noted, however, that the appended drawings illustrate only selected embodiments of the invention and are therefore not to be considered limiting of scope, for the inventions may admit to other equally effective embodiments and applications. Additionally, the names of learning institutions, websites, suppliers of additional services and fictional students are for example purposes only. They are not meant to convey or intend that such entities are participants in the invention, or that the invention is limited to such entities or requires the participation of such specific entities.

FIG. 1 is a diagram illustrating the partnership relationships of entities participating in the preferred embodiment of the invention.

FIG. 2 is a diagram illustrating the flow of student information between the entities participating in the preferred embodiment of the invention.

FIG. 3 is a diagram illustrating the e-learning experience of the student in the preferred embodiment of the invention.

FIG. 4 is a diagram illustrating the flow of financial remuneration to the parties involved in the preferred embodiment of the invention.

### DETAILED DESCRIPTION OF THE PREFERRED EMBODIMENT

### Definitions

As used herein, the term “content provider learning institution” refers to any learning institution which provides an c-learning course to be offered to students through the invention herein.

As used herein, the term “e-learning” refers to any education which is initially transmitted to the student through digital, electronic, or other means of wired or wireless transmission. The student may participate in the education either while online, or through offline means, including without limitation by receiving the information from any device that may transmit information visually and/or aurally. Additionally, such offline means may include without limitation, podcasting.

As used herein, the term “e-learning course” refers to any course of education or training offered through e-learning means.

As used herein, the term “full bilateral learning institution” refers to any learning institution which is both a “content provider learning institution” and a “subscriber learning institution”, as such terms are defined herein.

As used herein, the term “learning institution” refers to any entity which provides education or training of any nature to students, including without limitation a graduate school, university, college, vocational school, technical school, or other school. Such term is not limited to institutions of higher learning.

As used herein, the term, “poducation.com” refers to an entity which implements and provides the invention referenced herein, including a website which resides on a computer server. Such entity and website need not have or implement such name.

As used herein, the term, “subscriber learning institution” refers to any learning institution which allows students enrolled at such learning institution to receive academic credit for the successful completion of e-learning courses offered through the invention herein.

Whereas it is known in the prior art to provide e-learning courses to students, embodiments of the present invention expand upon the distribution of e-learning courses by facilitating the offering of e-learning courses between learning institutions.

The preferred embodiment of the invention includes a website, referred to herein as “poducation.com” for the sake of convenience, which provides facilitation of the elements of the invention to both the student and the learning institutions.

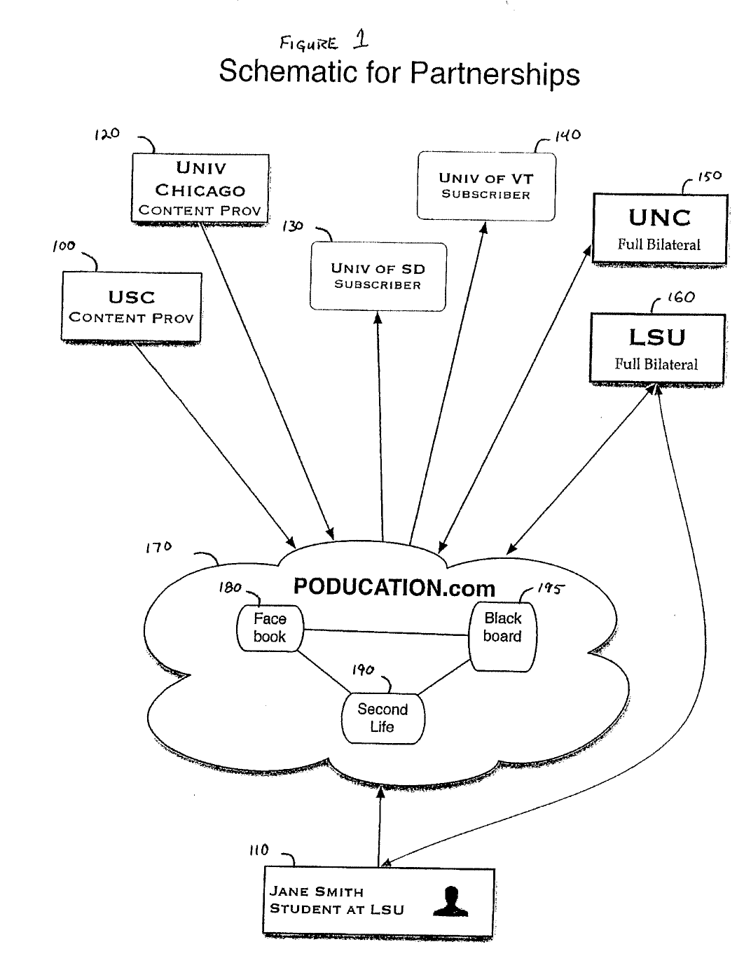

FIG. 1 presents the partnership relationships in the preferred embodiment between learning institutions, poducation.com 170, and a student 110, as well as additional resources implemented by poducation.com to enhance the e-learning experience of the student.

In this embodiment, sample universities the University of Southern California 100 and the University of Chicago 120 represent content provider learning institutions. Such content provider learning institutions have agreed to provide poducation.com with e-learning courses taught by instructors, which e-learning courses may be distributed to students enrolled at other learning institutions. A content provider learning institution may choose to allow any student to enroll in an e-learning course it provides to poducation.com, may choose to require that a student have successfully completed other prerequisite courses in order to enroll in such e-learning course, and/or may choose to limit student enrollment in such e-learning course based upon the learning institution in which the student is enrolled. The administration of such prerequisites is facilitated by poducation.com to ensure that the enrollment requirements of the content provider learning institution are met prior to allowing a student to enroll in such e-learning course.

Further, sample universities the University of South Dakota 130 and the University of Vermont 140 represent subscriber learning institutions. Poducation.com provides such subscriber learning institutions with the applicable e-learning course syllabus and other information as may be required by the subscriber learning institution, for review and approval by such subscriber learning institutions. The subscriber learning institutions review such syllabus and other course materials as may be required by them in advance of the e-learning course being offered to its students, to determine whether such institution will provide academic credit to its students which successfully complete such e-learning course, and how much credit will be provided by the subscriber learning institution. If such e-learning course is approved by the subscriber learning institution, such institution will offer such e-learning course in its course catalog. Subject to any prerequisite enrollment requirements set by the content provider learning institution, subscriber learning institutions may choose to allow any student enrolled at such learning institution to enroll in a particular e-learning course made available through poducation.com, may choose to require that a student have successfully completed other prerequisite courses in order to enroll in such e-learning course, and/or may choose to limit student enrollment in such e-learning course based upon the content provider learning institution. Subscriber learning institutions may also designate how many e-learning courses they will allow students enrolled at such institutions to take per semester. The administration of such prerequisites is facilitated by poducation.com to ensure that the enrollment requirements of the subscriber learning institution are met prior to allowing a student to enroll in such e-learning course.

Further, sample universities the University of North Carolina 150 and Louisiana State University 160 represent full bilateral learning institutions. Such full bilateral learning institutions take the role of both content provider learning institution, in that they offer e-learning courses through poducation.com, and in that they allow students enrolled at such learning institutions to receive academic credit for the successful completion of e-learning courses made available through poducation.com. In that regard, such full bilateral learning institutions have the same rights as content provider learning institutions to restrict enrollment in e-learning courses provided by such learning institution to poducation.com, as well as the same rights as subscriber learning institutions to restrict enrollment of students enrolled at such learning institution to receive academic credit for e-learning courses made available through poducation.com.

Poducation.com 170 represents a website which facilitates the inter-institution offering of e-learning courses provided by learning institutions. In the preferred embodiment of the invention, in addition to the facilitative functions referenced herein, poducation.com also provides options to the learning institution and the student 110 to enhance the educational experience of participating in the e-learning course, as referenced below.

Blackboard 195 represents a means of obtaining the e-learning course from the content provider learning institution, presenting the e-learning course to the student, enabling the standardization of evaluations of student performance in e-learning courses with the performance evaluation criteria of the subscriber learning institution in which the student is enrolled, and the actual reporting of the evaluation of a student's performance in such e-learning course to the subscriber learning institution in which the student is enrolled. Such course may be offered through online means requiring that the student be online to participate, and/or through offline means so that the student may download the course and view it or participate in it at the student's convenience. Blackboard is merely representative of such means and is not indicative of being limited to products offered by blackboard.com, nor does the reference to such company indicate that such company's products must be implemented, nor does such reference imply any connection between the inventor, the invention and/or such company.

Facebook 180 represents a means of providing an internet based social network to the student so that the student may interact with other students enrolled in the e-learning course. Facebook is merely representative of such means and is not indicative of being limited to products offered by facebook.com, nor does the reference to such company indicate that such company's products must be implemented, nor does such reference imply any connection between the inventor, the invention and/or such company.

Second Life 190 represents a means of providing an Internet based virtual space to the student where the student may attend a class through online participation, participate online in office hours for questions and assistance, and/or participate online in other course activities at a specified time. Second Life is merely representative of such means and is not indicative of being limited to products offered by secondlife.com, nor does the reference to such company indicate that such company's products must be implemented, nor does such reference imply any connection between the inventor, the invention and/or such company.

In the preferred embodiment, subscriber learning institutions receive a payment for tuition for the administration of reviewing and approving e-learning courses offered through poducation.com, as well as the administration of providing academic credit to students who successfully complete such e-learning courses. Content provider learning institutions retain ownership of the intellectual property rights of e-learning courses which are provided to poducation.com, and also receive a royalty payment for the use of such e-learning courses by poducation.com. Full bilateral learning institutions receive both types of payments.

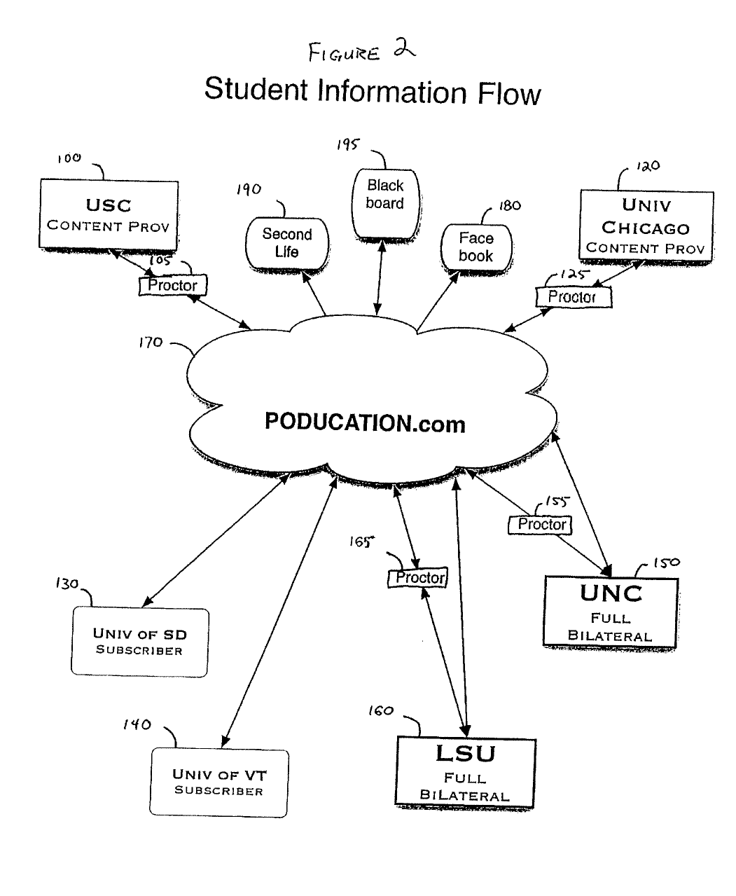

FIG. 2 presents the student information flow in the preferred embodiment between learning institutions, poducation.com 170, as well as additional resources implemented by poducation.com to enhance the e-learning experience of the student.

In this embodiment, sample universities the University of Southern California 100 and the University of Chicago 120 represent content provider learning institutions. As referenced above, the content provider learning institutions provide poducation.com with e-learning courses to be offered to students. The content provider learning institutions University of Southern California and the University of Chicago appoint and provide proctors 105 and 125, respectively, for each e-learning course, which proctors are available to the student through poducation.com for questions and assistance with the course. Said proctors may be chosen by the professor or instructor of the e-learning course, although any means of choice of proctors by the content provider learning institution is within the scope of this invention. The student may communicate with the proctor through a variety of means, including video chat and/or virtual office hours through Second Life 190, e-mail through Blackboard 195 and/or Facebook 180, and/or instant messaging. The proctors also evaluate the student's performance in the e-learning course and report such evaluation to poducation.com for reporting to the learning institution in which the student is enrolled.

Further, sample universities the University of South Dakota 130 and the University of Vermont 140 represent subscriber learning institutions, which do not provide proctors because such institutions do not provide e-learning courses to poducation.com. Sample universities the University of North Carolina 150 and Louisiana State University 160 represent full bilateral learning institutions. Because such full bilateral learning institutions take the roles of both subscriber learning institution, in that they allow students enrolled at such institutions to receive academic credit for the successful completion of e-learning courses made available through poducation.com, and content provider learning institution in that they offer e-learning course(s) through poducation.com, such full bilateral learning institutions provide proctors 155 and 165, respectively, for the e-learning courses they make available through poducation.com, in the same manner as content provider learning institutions.

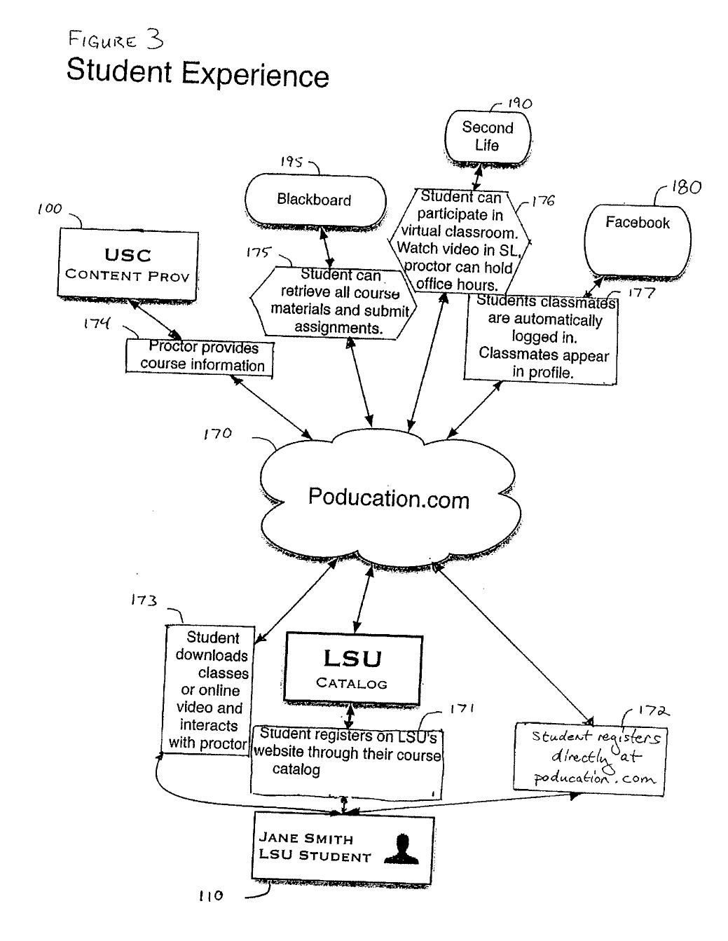

FIG. 3 presents the student experience in the preferred embodiment. The student 110 enrolled at sample university Louisiana State University wishes to take an e-learning course offered by sample university the University of Southern California 100 and to be provided with academic credit for such course by Louisiana State University.

The student registers on the website of Louisiana State University through its course catalog 171. Because Louisiana State University is a full bilateral learning institution, and because the e-learning course has already been provided by the proctor 174 to poducation.com 170 and approved by Louisiana State University, Louisiana State University offers the e-learning course to the student through poducation.com. In the alternative, the student may also register for the e-learning course directly through poducation.com 172.

The student then may download e-learning classes and/or watch online videos of the e-learning course, and also may interact with the proctor through poducation.com 173.

In particular, the student retrieves course materials and submits assignments through poducation.com via Blackboard 175. The student may also participate online in a virtual classroom, watch class videos online and participate online in office hours with the proctor through poducation.com via Second Life 176. When the student attends a class in the e-learning course, the student and classmates in the e-learning course are made aware of the attendance of the others by being automatically logged in through poducation.com via Facebook 177.

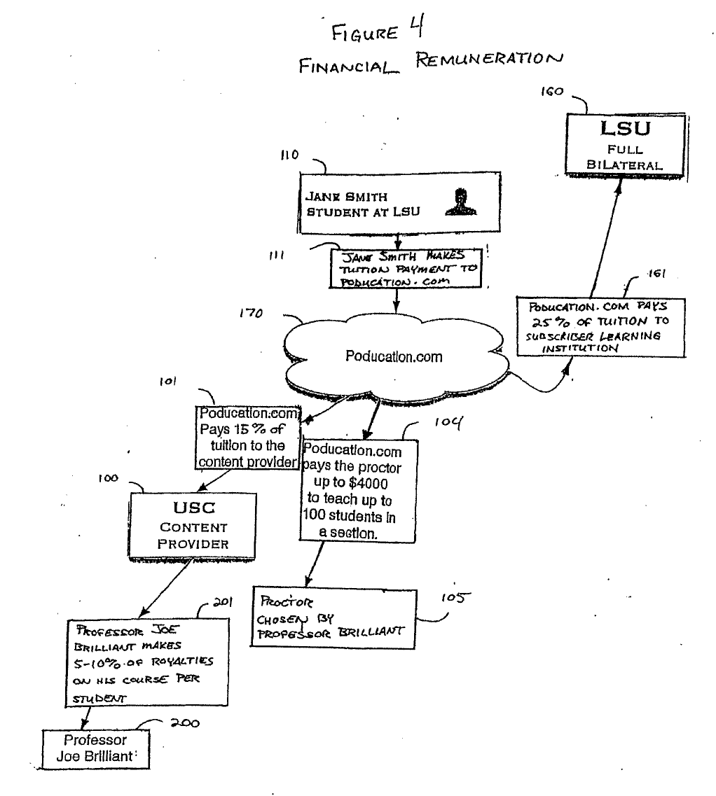

FIG. 4 presents the flow of financial remuneration to the parties involved in the preferred embodiment of the invention. The student 110 is enrolled at sample university Louisiana State University 160. Because Louisiana State University in this example is a full bilateral learning institution, it is also a subscriber learning institution. The student enrolls in an e-learning course offered by sample university the University of Southern California 100, a content provider learning institution, through poducation.com 170.

The student 110 makes a tuition payment 111 to poducation.com 170. In one preferred embodiment of the invention, the tuition amount is $595.00 per e-learning course and does not vary from course to course, although any tuition amount, as well as tuition amounts which vary from course to course, are within the scope of the invention.

Poducation.com pays a portion of the tuition payment 161 to the subscriber learning institution, in this example, sample university Louisiana State University. In one preferred embodiment of the invention, the amount of the tuition payment paid to the subscriber learning institution is 25% of the tuition payment made by the student to poducation.com, although any amount of the tuition payment paid to the subscriber learning institution is within the scope of the invention.

Poducation.com also pays a portion of the tuition payment 101 to the content provider learning institution, in this example, sample university the University of Southern California 100. In one preferred embodiment of the invention, the amount of the tuition payment paid to the content provider learning institution is 15% of the tuition payment made by the student to poducation.com, although any amount of the tuition payment paid to the content provider learning institution is within the scope of the invention.

The content provider learning institution, in this example, sample university the University of Southern California, pays a royalty 201 to the professor or instructor of the e-learning course 200. In one preferred embodiment of the invention, the amount of the tuition payment paid by the content provider learning institution to the professor or instructor is between 5% to 10% of the tuition payment made by the student to poducation.com, although any royalty amount paid by the content provider learning institution to the professor of the e-learning course is within the scope of the invention.

Poducation.com also remunerates 104 the proctor 105 of the e-learning course for his/her services. In one preferred embodiment of the invention, poducation.com pays the proctor up to a maximum amount of $4,000 to provide services to an e-learning class of up to a maximum number of 100 students per class, although any amount paid to a proctor by any method is within the scope of the invention. It is also within the scope of the invention for remuneration to the proctor to be paid by the content provider learning institution.

It should again be understood that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention. cm 1 claim:

1. A method of facilitating online education between learning institutions, comprising the steps of obtaining an e-learning course taught by an instructor and course materials from a content provider learning institution; providing the applicable e-learning course syllabus to a subscriber learning institution for the review and approval of such subscriber learning institution for students enrolled at such subscriber learning institution to receive academic credit for the successful completion of such e-learning course; obtaining the approval of such subscriber learning institution for students enrolled at such subscriber learning institution to receive academic credit for the successful completion of such e-learning course; enrolling students from such subscriber learning institution in such e-learning course through a website; providing such e-learning course to students of the subscriber learning institution; obtaining evaluations of the students' performances in the e-learning course from the content provider learning institution; and providing said evaluations of the students' performances in such e-learning course to the subscriber learning institution in which the students are enrolled.

2. The method of claim 1, further comprising the step of providing additional course information as requested by the subscriber learning institution, for the review and approval of such subscriber learning institution for students enrolled at such subscriber learning institution to receive academic credit for the successful completion of such e-learning course.

3. The method of claim 1, further comprising the step of standardizing the performance evaluations of students enrolled in such e-learning course with the performance evaluation criteria of the respective subscriber learning institutions.

4. The method of claim 1, further comprising the step of providing such e-learning course to students of the subscriber learning institution through online means.

5. The method of claim 1, further comprising the step of providing such e-learning course to students of the subscriber learning institution through offline means.

6. The method of claim 1, further comprising the step of providing a proctor from the content provider learning institution for assistance to students, and providing evaluations of the students' performance in the e-learning course.

7. The method of claim 1, further comprising the step of offering audiovisual presentations of lectures in the course.

8. The method of claim 1, further comprising the step of providing an internet based social network to students for interaction between students enrolled in the e-learning course.

9. The method of claim 1, further comprising the step of providing an Internet based virtual space to students where students may attend a class in the e-learning course through online participation.

10. The method of claim 1, further comprising the step of providing an internet based virtual space to students where students may participate online in office hours held by a proctor for questions and assistance.

11. The method of claim 1, further comprising the step of providing an Internet based virtual space to students where students may participate online in other activities in the e-learning course at a specified time.

12. The method of claim 1, further comprising the step of restricting the enrollment of a particular student in such e-learning course based upon the student's having successfully completed certain pre-requisite courses, as determined by the content provider learning institution.

13. The method of claim 1, further comprising the step of restricting the enrollment of a particular student in such e-learning course based upon the subscriber learning institution in which the student is enrolled, as determined by the content provider learning institution.

14. The method of claim 1, further comprising the step of restricting the enrollment of a particular student in such e-learning course based upon the student's having successfully completed certain pre-requisite courses, as determined by the subscriber learning institution in which the student is enrolled.

15. The method of claim 1, further comprising the step of restricting the enrollment of a particular student in such e-learning course based upon the content provider learning institution, as determined by the subscriber learning institution in which the student is enrolled.

16. The method of claim 1, further comprising the step of restricting the total number of e-learning courses a particular student may take during a particular period of time, as determined by the subscriber learning institution in which the student is enrolled.

17. The method of claim 1, further comprising the step of said website collecting the tuition payments from students enrolling in such e-learning course.

18. The method of claim 17, further comprising the step of said website providing a portion of said tuition payments to the respective subscriber learning institutions in which such students are enrolled.

19. The method of claim 17, further comprising the step of said website providing a portion of said tuition payments to the content provider learning institution which provided such e-learning course.

20. The method of claim 6, further comprising the step of said website collecting the tuition payments from students enrolled in such e-learning course.

21. The method of claim 20, further comprising the step of said website providing a portion of said tuition payments to such proctor.

22. The method of claim 6, further comprising the step of providing said proctor with a fixed amount of financial remuneration per each student enrolled in such e-learning course.
